(19) United States
(12) Patent Application Publication
(10) Pub. No.: US 2019/0381391 A1
(43) Pub. Date: Dec. 19, 2019

(54) CARD GAME

(71) Applicant: Mark Jason HARLOW, Middleton (AU)

(72) Inventor: Mark Jason HARLOW, Middleton (AU)

(21) Appl. No.: 16/480,151

(22) PCT Filed: Jan. 31, 2018
(86) PCT No.: PCT/AU2018/050059

§ 371 Date: Jul. 23, 2019

(30) Foreign Application Priority Data
Jan. 31, 2017 (AU) 2017900271

(51) Int. Cl. A63F 1/02

(52) U.S. Cl. CPC A63F 1/02; G07F 17/3293

(57) ABSTRACT

A card game for playing in a casino environment, with a dealer and one or more players. Before play commences the players place an ante bet. Each player and the dealer are then dealt 2 cards. The object of the game is to get a pair of cards scoring higher than the dealer, with a wild card being able to make a pair with any other card and two wild cards being the highest score possible. Without a pair the score is determined by the sum of the cards numeric values. Before the dealer reveals their cards, the players inspect their cards and can either forfeit their ante bet, or place a further bet equivalent to the original ante bet. A side bet is also available for receiving one or two wild cards.

### FIELD OF THE INVENTION

The present invention relates to a card game suitable for casino gambling tables or online equivalents.

### BACKGROUND TO THE INVENTION

The present invention is a card game and is discussed in terms of a casino environment and being played on a gaming table. It is to be understood that the card game of the invention may also be implemented by a computing system and played online or on dedicated machines.

Card games have historically been popular in casinos, however they have been on the decline in recent years as they have become stale. Patrons have also turned away from traditional card games as many casinos have changes the rules, often leading to confusion or a sense of unfairness.

Casinos are actively seeking new card games to entice patrons to their casinos. There is even an annual competition held in Las Vegas for new games. To be adopted by casinos a game must be quick to learn, quick to play, have some excitement for the patrons and offer the casinos a reasonable and statistically predictable return. For over twenty years no new game has had enough appeal to be widely adopted by the casinos.

The object of this invention is to provide a new card game to alleviate the above problem, or at least provide the public with a useful alternative.

### SUMMARY OF THE INVENTION

In a first aspect the invention provides a method of playing a card game between a dealer and a player using a plurality of cards including at least two wild cards, comprising: the player placing an ante bet; the dealer dealing 2 cards to the player and 2 cards to themselves; the player inspecting the cards that the player has been dealt and on consideration of the cards either forfeiting the ante or placing a bet equivalent to the ante bet; the dealer revealing the cards that dealer has been dealt; determining the winner of the game by comparing the cards dealt to the dealer with the cards dealt to the player in accordance with a set of card scoring rules; and, if the player is determined to be the winner then paying the player a payout in accordance to a set of payout rules.

Preferably the method includes the further step of the player placing a bet on receiving at least one wild card.

Preferably the game is played with at least one deck of custom cards, each deck comprising 2 wild cards and four each of numeric cards with values from 1 to 12.

The game may also be played with at least one deck of standard playing cards, each deck comprising 2 jokers, and 4 each of aces, kings, queens, jacks and numeric cards from 2 to 10, and wherein the jokers assume the role of wild cards. Preferably the aces assume a numeric value of 11 and the kings, queens, and jacks assume a numeric value of 10.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows a playing felt designed for the game of the invention.

### DRAWING COMPONENTS

The drawings include the following integers.
10 playing felt
12 logo
14 dealer side
16 player side
20 ante position
30 side bet position
40 player card boxes
51, 52 dealer card boxes

### DETAILED DESCRIPTION OF THE INVENTION

The following detailed description of the invention refers to the accompanying drawing. Wherever possible, the same reference numbers will be used in the drawing and the following description to refer to the same and like parts.

The present invention provides a card game using either a traditional or a custom deck of cards that is quick to learn, quick and fun to play and provides a reasonable and statistically predictable return for casinos.

The game is played with a dealer and one or more players. Before play commences the players place an ante bet. Each player and the dealer are then dealt 2 cards. The object of the game is to get a pair of cards scoring higher than the dealer, with a wild card being able to make a pair with any other card and two wild cards being the highest score possible. Without a pair the score is determined by the sum of the cards numeric values. Before the dealer reveals their cards, the players inspect their cards and can either forfeit their ante bet, or place a further bet equivalent to the original ante bet. A side bet is also available for receiving one or two wild cards.

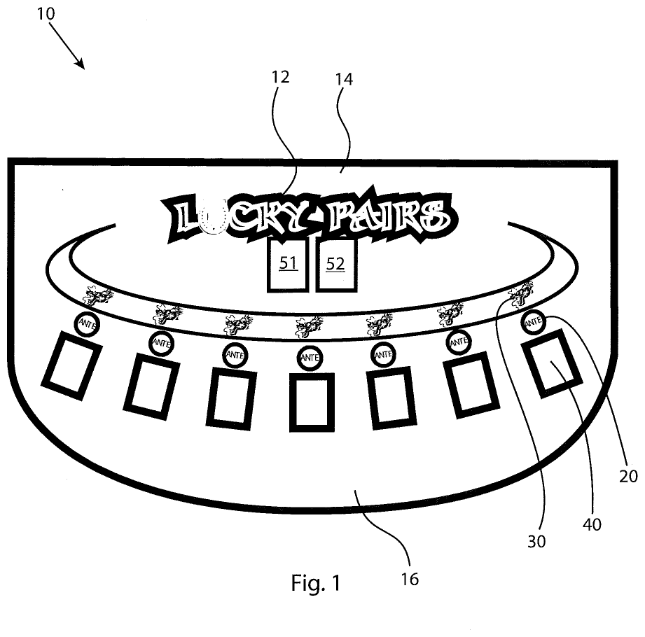

FIG. 1 shows an example playing felt for use with the game. In this instance it is configured for 7 players and will fit conveniently on a standard Blackjack table. A 10 player version fits readily on a standard Baccarat table. Playing felts for other numbers of players and varying layouts can readily be envisaged. The playing felt includes a game logo 12, ante position 20 for players to place ante bets, side bet position 30 for players to place side bets, player card box 40 to receive the cards dealt to a player and dealer card boxes 51 and 52 for receiving the cards that the dealer deals to himself. The playing felt includes places for further features (not shown) in common with most gaming tables such as a pay table, chip tray, drop box and card dispenser.

Following is a detailed description of game play. The game can be played with varying types of decks including standard cards and customised playing cards. The game will be discussed in a generic sense and then specifics for two different types of cards will be discussed. The game can be played with a single deck or multiple decks of cards. Various pay tables are used depending on the type of cards, the number of decks and the desired return by the casino.

The game is played at a table with a playing felt 10 as shown in FIG. 1. The dealer stands behind the dealer side 14 of the table and the players sit on stools behind the player side 16 of the table adjacent to a player card box. To receive cards the players must first place a wager in the ante position 20. Optionally the players also place a bet in the side bet position 30. Once the ante and side bets are in place the dealer will deal a pair of cards to each player face down in the player card boxes 40 and a card face down in each of the dealer card boxes 51 and 52.

With all cards being dealt the players will then inspect their cars and decide whether or not to continue the game. At all times the players cards must remain above the table. If the players choose not to proceed, most likely if they don't have a pair and have low valued numeric cards, they place their cards face down in their player card boxes without a further bet being placed on top of the cards. In this situation the players forfeit their ante bets to the dealer. If the players choose to continue to play they must place a further bet equal to the ante bet on top of their cards face down in the players card box. Betting is closed by the dealer calling “no more bets” after which the dealer will remove the forfeited ante bets and losing cards and then turn over both of his cards. If the dealer does not have a pair or a high enough opening card total (typically 12 or 14) the dealer will not pay and announce “dealer does not open, paying all antes” and proceed to payout each player at a ratio of 1:1 of their ante. The players further bets will also be returned but with no payout. The dealer will also reveal each of the players cards to validate any wild card bets.

If the dealer has a pair or sufficient card total they will announce “dealer has opened with X” with X being a description of the dealer's cards. The dealer will then reveal each players cards in turn from left to right and assess if a player has won, drawn or lost by comparing the players cards to the dealers cards. Scores are determined by the following rules from highest to lowest: a pair of wild cards; a pair of cards with the value determined by the rank of the cards with a wild card able to be used to make a pair with any other card and will assume the rank of the other card; and, the numeric sum of each cards values. The rank and numeric value of each card is discussed further below. If the dealer scores higher than a player then the player will forfeit their ante bet and further bet. If the dealer and a player score equally then the players will retain their ante bets and further bets. If a player scores higher than the dealer then the player will retain their ante and receive a payout on their further bet as discussed further below.

The game can be played with a variety of card types, either customised or standard playing decks with rules adjusted to suit. A preferred example of a custom card deck includes four each of numeric cards from 1 to 12 plus two wild cards to give 50 cards per deck. A standard card deck with two jokers can be used with the jokers being used as wild cards. For determining the highest pairs, cards assume their normal rank with Aces high. For determining numeric totals, Aces are assigned a numeric value of 11; Kings, Queens and Jacks are assigned the same numeric value of 10; and the numbered cards assume their numeric face value. Other value assignments can be made with pay tables adjusted to suit.

With the preferred example deck the dealer opens with a pair or a total of 12 or more. For a standard deck a total of 14 or more is used.

If a dealer beats a player the player will lose their further bets and ante bets. In the case of a drawer the players will have their further bets and ante bets returned. If the player wins they will retain their ante bet and their further bet and receive a payout on their further bet depending on their winning hand. For a game using a single deck, a pair of wild cards will be paid out at 10:1; a pair, including a pair formed with a wild card, at 2:1; and, a higher two card total at 1:1. For side bets the payout depends on the type of deck being used. For the preferred custom deck the payout is 8:1 for a single wild card and 250:1 for two wild cards. For a standard deck the payout is 9:1 for a single wild card and 250:1 for two wild cards. For games using 6 or 8 decks of cards a pair of wild cards will be paid out at 200:1 for both custom and standard decks, whilst a pair with zero or one wild card will be paid out at 7:1 for custom decks and at 8:1 for standard decks.

Well known analytical methods can be used to determine optimal playing strategies and returns for players and casinos. With the card configurations and payout figures discussed above and using an optimal playing strategy, the Return to Player (RTP) for custom cards will be: 99.16% for 1 deck, 99.8% for 6 decks and 99.83% for 8 decks. The corresponding House Edge (HE) measurement scaled to initial wager will be 1.41% for 1 deck, 0.34% for 6 decks and 0.28% for 8 decks. For standard decks the RTP figures are 98.21% for 1 deck, 98.96% for 6 decks and 99.00% for 8 decks; and the HE FIGS. 3.38% for 1 deck, 2.09% for 6 decks and 2.00% for 8 decks.

The reader will now appreciate the present invention which provides a card game for gambling that is quick to learn, quick and fun to play and provides a reasonable and statistically predictable return for casinos.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A method of playing a card game between a dealer and a player using a plurality of cards including at least two wild cards, comprising:
the player placing an ante bet;
the dealer dealing two cards to the player and two cards to themselves;
the player inspecting the cards that the player has been dealt and, on consideration of the cards, either forfeiting the ante bet or placing an additional bet equivalent to the ante bet;
the dealer revealing the cards that the dealer has been dealt;
determining a winner of the game by comparing the cards dealt to the dealer with the cards dealt to the player in accordance with a set of card scoring rules; and,
if the player is determined to be the winner, then paying the player a payout in accordance with a set of payout rules.

2. The method of claim 1, further comprising a step of the player placing the additional bet on receiving at least one wild card.

3. The method of claim 1, wherein the game is played with at least one deck of custom cards, each deck comprising two wild cards and four each of numeric cards with values from 1 to 12.

4. The method of claim 1, wherein the game is played with at least one deck of standard playing cards, each deck comprising two jokers, and four each of aces, kings, queens, jacks and numeric cards from 2 to 10, and wherein the jokers assume the role of wild cards.

5. The method of claim 4, wherein the aces assume a numeric value of 11 and the kings, queens, and jacks assume a numeric value of 10.
